(19) United States
(12) Patent Application Publication
(10) Pub. No.: US 2003/0076011 A1
(43) Pub. Date: Apr. 24, 2003

(54) Containment and testing enclosure

(76) Inventor: James D. Brownfiel JR., Middle Island, NY (US)

Correspondence Address: THE H.T. THAN LAW GROUP, SUTTON EXECUTIVE CENTER, 3201 NEW MEXICO AVEUE, N.W., SUITE 350, WASHINGTON, DC, 20016, US

(21) Appl. No.: 09/982,923

(22) Filed: Oct. 22, 2001

(51) Int. Cl. A61G 11/00

(52) U.S. Cl. 312/1

(57) ABSTRACT

The present invention is directed to an enclosure with a base and a movable lid. When the lid is open, a piece of potentially harmful mail can be placed within the enclosure. The enclosure may include at least one latch for sealing the lid to the base so that an air-tight chamber is formed within the closed enclosure. Preferably, the latch can be broken-away to secure the lid in the closed position and deter tampering with the enclosure. The enclosure may also include a self-sealing valve member for allowing a sample of air or particulate within the closed enclosure to be taken and tested. The enclosure may further include tools such as a letter opening instrument, a sampling instrument, and/or testing material.

### FIELD OF THE INVENTION

The present invention relates to enclosure for opening mail that may contain dangerous material, such as harmful biological or chemical agents. More particularly, the present invention relates to an enclosure for safely opening and testing mail and selectively sealing possibly contaminated mail therein.

### BACKGROUND OF THE INVENTION

Mail services and overnight courier services remain the primary means for people and businesses to communicate and send items. Recently, bacteria that can cause an anthrax infection to the recipients or other harmful biological or chemical agents have been mailed. Such harmful agents can be a powdery substance, a pasty substance, or a liquid. In the case of bacterium that causes anthrax, when anthrax-containing envelopes are opened, the bacteria can enter a person's system in several ways. If the bacterium is small enough, it can become air borne and be inhaled. This bacterium can also contact the person's skin and enter their system, for example, through openings in the skin. As a result of such an exposure, a person can develop the anthrax infection and become sick. In most cases, persons with an anthrax infection can be treated with antibiotics, particularly if treatment occurs soon after infection. Anthrax infection, however, can be fatal. Although anthrax is treatable and not contagious, other harmful non-treatable and/or contagious biological and/or chemical agents can be sent through the mail.

Once a harmful biological or chemical agent is discovered, public health and safety authorities usually quarantine the potentially contaminated area for testing and decontamination. The contaminated area can be a single room, several floors of a building, or an entire building and beyond. The evacuation of people and disruption of work due to a quarantine can be alarming and costly. And the decontamination can be time consuming and labor intensive. In the event of a potential contamination, public authorities also conduct tests on potentially exposed people so that they can be treated. Testing can be frightening to these people, and can also be costly, time consuming, and labor intensive.

Although the majority of mail does not contain harmful biological and/or chemical agents, a small percentage of letters or packages may contain these agents. The potentially harmful mail may have several clues such as misspelled words, incorrect addressee information, no return address, excessive packaging and excessive postage. Hence, if the potentially harmful mail can be identified and separated, it can be opened in a safe environment to minimize the spread of the harmful agents. Thus, it is desirable to have a way to open suspicious mail at work or at home while minimizing the possibility of releasing a harmful biological and/or chemical agent.

### SUMMARY OF THE INVENTION

The present invention is directed to an enclosure capable of sealing a contaminated package and opening it. The enclosure comprises a housing member having a base and a lid coupled to the base, wherein the housing member is adapted to receive said package. The enclosure further comprises a latch coupled to the housing member to prevent fluid communication between an environment inside the enclosure and outside environment, and a self-sealing valve disposed on the enclosure to permit selective sampling of the environment inside the enclosure. The enclosure further comprises at least one glove and preferably two gloves connected to the housing member. The glove is adapted to receive a user's hand such that the user may manipulate the package after the package is sealed inside the enclosure to determine the content of the package. The latch preferably comprises a breakaway handle that can be separated from the latch to minimize the possibility of separation of the lid from the base after the package is sealed within the enclosure.

An O-ring may be disposed between the lid and the base, and the O-ring is preferably disposed within a channel formed between the lid and the base.

The self-sealing valve preferably comprises a body member and a self-sealing member. The self-sealing member defines a normally closed channel wherein said normally closed channel is adapted to allow an insertion of a hollow needle to selectively sample the environment inside the enclosure. The self-sealing valve may further comprise a lead-in channel to guide the insertion of the hollow needle, and a cap coupled to the body member.

In accordance to another aspect of the invention, the latch is disposed on one of either the lid or the base and comprises a shaft and a first projection coupled to the shaft. The breakaway handle is connected to the shaft by a weakened section, such that when a user actuates the handle the first projection cooperates with a first notch defined on the other one of either the lid or the base to couple the lid to the base. The latch may further comprise a second projection coupled to the shaft, such that said second projection cooperates with a tapered second notch defined on the other one of either the lid or the base when the user actuates the handle to assist the coupling of the lid to the base.

The enclosure of the present invention may further comprise an instrument disposed therein for opening the package. The enclosure may also comprise testing materials disposed therein to identify the contamination.

It is also desirable if the mail can be opened in a secure environment and tested within the secure environment.

### BRIEF DESCRIPTION OF THE DRAWINGS

In the accompanying drawings which form a part of the specification and are to be read in conjunction therewith and in which like reference numerals are used to indicate like parts in the various views:

FIG. 1 is a partial, exploded, perspective view of a first embodiment of an enclosure of the present invention with a gasket disassembled therefrom, wherein the enclosure is open and certain components are omitted for clarity;

FIG. 2 is a front view of the enclosure of FIG. 1, wherein the enclosure is open;

FIG. 2A is a front, perspective view of a lock block for use with the enclosure of FIG. 1;

FIG. 2B is a rear, perspective view of the lock block of FIG. 2A;

FIG. 3 is a partial, enlarged, cross-sectional view of a glove port of the enclosure of FIG. 1 with a glove coupled thereto;

FIG. 4 is a partial, enlarged, cross-sectional view of a test port of the enclosure of FIG. 1 with a self-sealing member therein;

FIG. 5 is a front view of the enclosure of FIG. 2, wherein the enclosure is closed;

FIG. 6 is an enlarged, side view of a latch for use with the enclosure of FIG. 1 within a lid, wherein the latch is unbroken and in an unlocked position;

FIG. 7 is an enlarged, side view of the latch and lid of FIG. 6, wherein the latch is unbroken and in a locked position;

FIG. 8 is an enlarged, side view of the latch and lid of FIG. 6, wherein the latch is in the locked position and is broken to minimize the risk of undesirable opening of the enclosure and for tamper-identification and deterrence;

FIG. 9 is a partial, enlarged, top view of the latch of FIG. 6 and the lock block of FIG. 2A, wherein the latch is in the unlocked position and unbroken;

FIG. 10 is a partial, enlarged, top view of the latch of FIG. 7 and the lock block of FIG. 2A, wherein the latch is in the locked position and unbroken;

FIG. 11 is a partial, enlarged, plan view of the latch of FIG. 8 and the lock block of FIG. 2A, wherein the latch is in the locked position and broken;

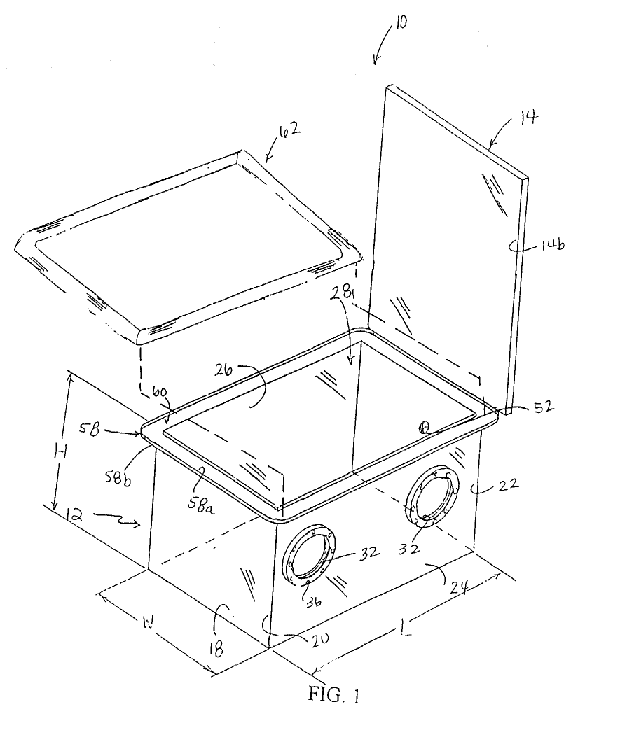

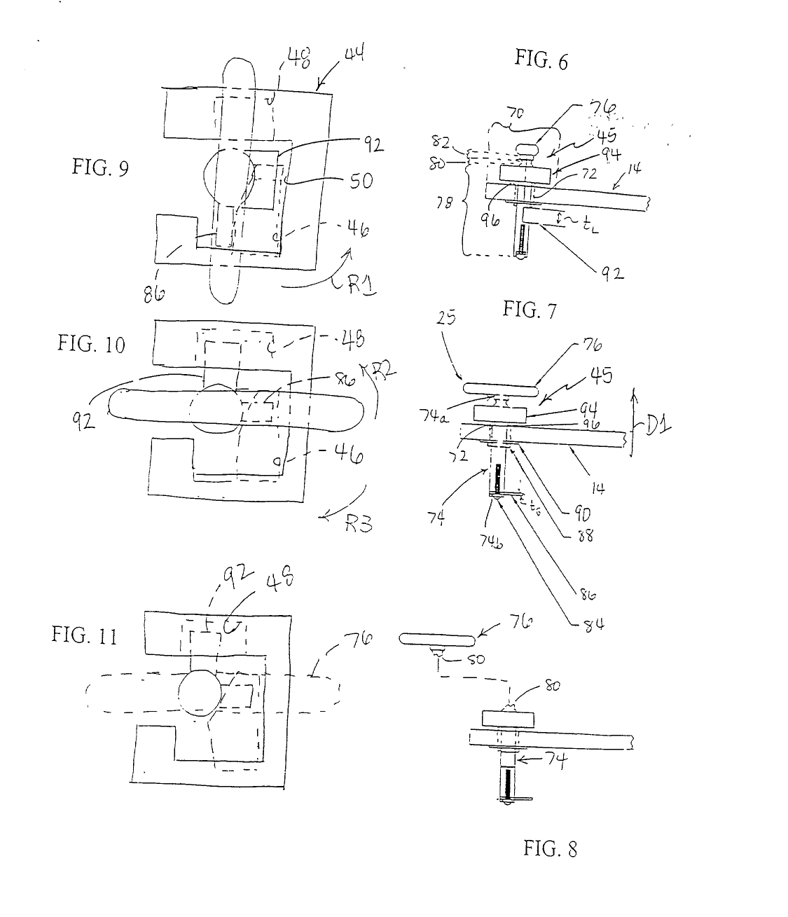

FIG. 6A is an enlarged, side view of a second embodiment of the latch for use with the enclosure of FIG. 1, wherein the latch is unbroken and in the unlocked position;

FIG. 7A is an enlarged, side view of the latch of FIG. 6A for use with the enclosure of FIG. 1, wherein the latch is unbroken and in the locked position;

FIG. 8A is an enlarged, side view of the latch of FIG. 6A for use with the enclosure of FIG. 1, wherein the latch is broken and in the locked position;

FIG. 9A is a partial, enlarged, plan view of the latch of FIG. 6A and a second embodiment of a lock block, wherein the latch is in the unlocked position and unbroken;

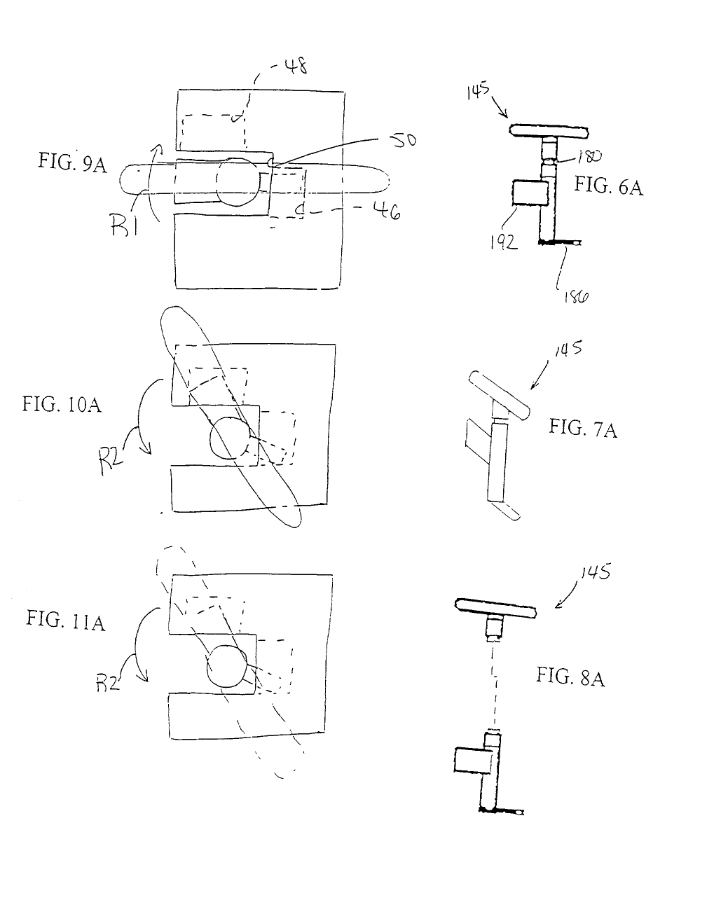

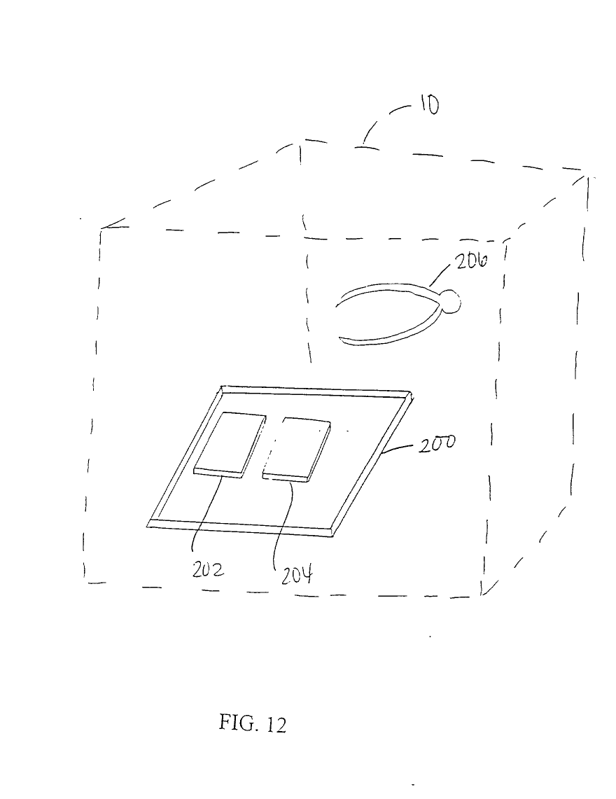

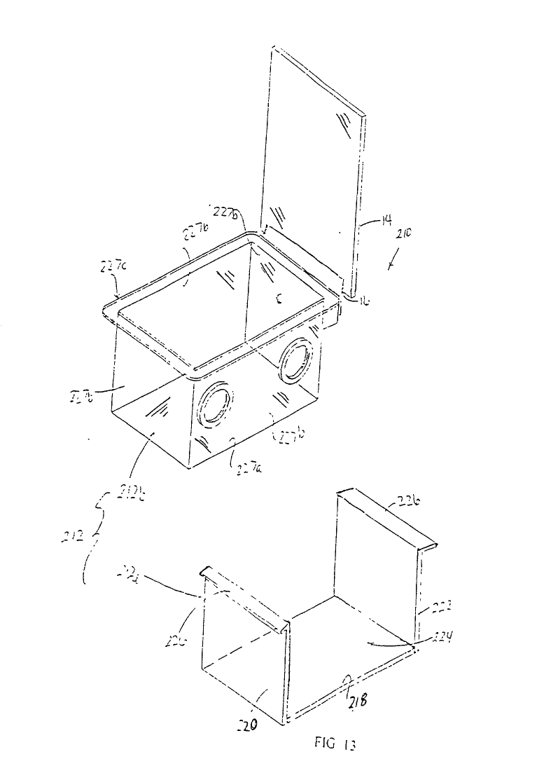

FIG. 10A is a partial, enlarged, plan view of the latch of FIG. 7A and the lock block of FIG. 9A, wherein the latch is in the locked position and unbroken;

FIG. 11A is a partial, enlarged, plan view of the latch of FIG. 8A and the lock block of FIG. 9A, wherein the latch is in the locked position and broken;

FIG. 12 is perspective view of a plurality of tools for use with the enclosure of FIG. 1; and

FIG. 13 is a partial, exploded, perspective view of a second embodiment of the enclosure of the present invention, wherein the enclosure is open.

### DETAILED DESCRIPTION OF THE INVENTION

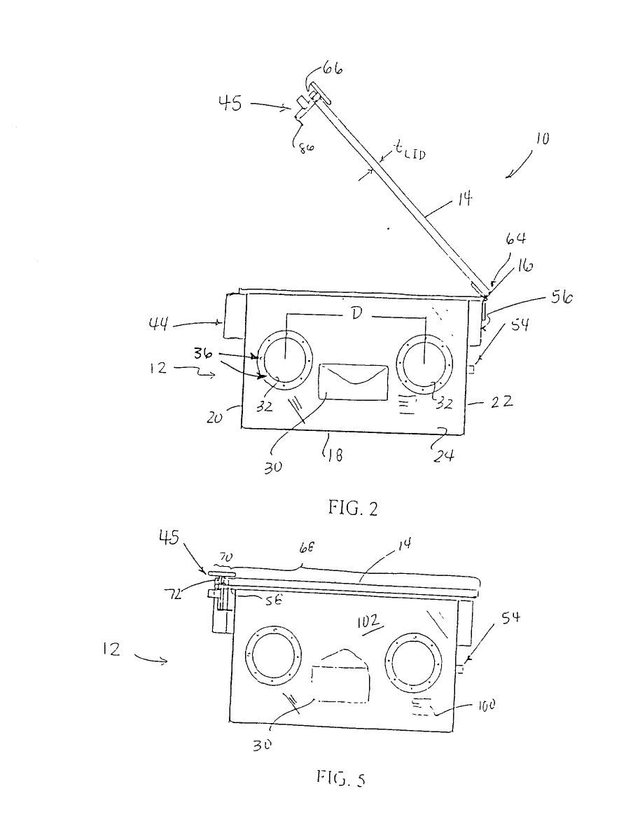

Referring to FIG. 1, an enclosure 10 in accordance with the present invention is shown. The enclosure 10 comprises a base 12 and a movable lid 14. The lid 14 is pivotally connected to the base 12 by a hinge 16, as shown in FIG. 2. The base 12 includes a bottom wall 18 for supporting four left, right, front and rear upstanding side walls 20, 22, 24, and 26, respectively, to form an opening 28 adapted to be closed and sealed by the movable lid 14.

In the preferred embodiment, the base 12 and lid 14 are formed of a moldable plastic, such as Lexane, a polycarbonate resin made by General Electric Company. Other materials, such as ceramics, plastics, Plexiglas (acrylic), glass, PVC, CPVC, PVDF, and metals, alloys thereof, and the like can also be used so long as the base 12 can form a sealed environment with lid 14. Once the base 12 is molded, the base 12 is formed by a single integral piece of material. In an alternative embodiment, the walls 18-26 can be joined together using other techniques. For example, the walls 18-26 can joined together by techniques such as ultrasonic welding, welding, adhesive, and the like. But, molding is preferred for forming a robust and air-tight base 12.

Also in the preferred embodiment, at least one wall or the lid 14 is formed of a transparent material so that the contents of the enclosure 10 can be viewed, when the enclosure 10 is closed. In addition, preferably, at least one other wall is formed of an opaque material. The opaque material, preferably, is a color that offers a high-contrast to a white or light-colored potentially harmful agent that may be within a piece of mail 30, as shown in FIG. 2.

Turning again to FIG. 1 in the preferred embodiment, the bottom wall 18 and left and right walls 20 and 22 are opaque and black in color, which offers the highest contrast to white or a light color. Additionally in such a preferred embodiment, the front and rear walls 24, 26 and the lid 14 are transparent. Such a preferred enclosure, can be formed by laying-up the various opaque and transparent materials in a mold. Preferably, the left and right walls 20, 22 and the bottom wall 18 are formed by laying-up a black piece of plastic first then laying a transparent piece of plastic thereon. The front and rear walls 24, 26 and the lid 14 are formed by laying-up only the transparent material. Then the pieces are molded together. In an alternative embodiment, another combination of walls can be opaque and transparent and the present invention is not limited to the aforementioned configuration.

Referring to FIGS. 1-3, the front wall 24 of the base 12 defines two spaced-apart threaded glove ports or bores 32. A distance designated D extends between the centers of the threaded bores 32. Preferably, the distance D is about 20 inches so that a user's hands covered by protective gloves, one glove 34 being shown, can easily manipulate objects in the enclosure 10. The preferred diameter of each bore 32 is about 6 inches or any other size such that the user's hands can be inserted therethrough.

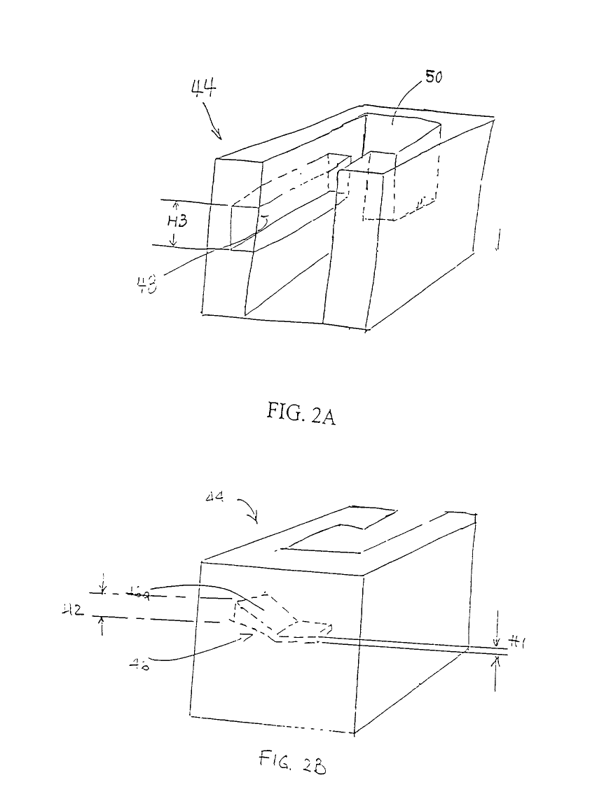

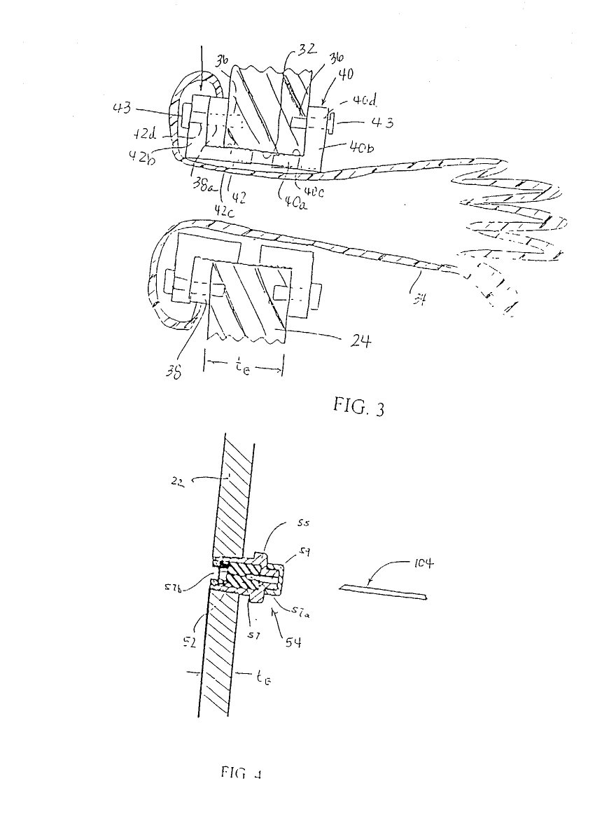

The front wall 24 further defines a plurality of circumferentially spaced apart threaded bolt holes 36 surrounding each glove bore 32. Suitable gloves 34 and operatively associated connectors 38 (as shown in FIG. 3) are commercially available from Renco Corporation located in Manchester, Mass. The glove 34 should be formed of a material that allows sufficient dexterity and protection to the user (i.e., the gloves should be impermeable to biological agents and the gloves should be inert to harmful chemical agents to prevent the biological and chemical agents from contacting the user's skin). One preferred glove material is natural rubber. Other suitable materials include nitrile, hypalon, viton, neoprene, butyl and other polymers or synthetic materials.

Referring to FIGS. 1 and 3, to securely couple the gloves 34 to the front wall 20 of the base 12, inner and outer flanges 40 and 42 are used. The glove 34 is inserted within the enclosure 10 through the glove bore 32. The inner flange 40 has a tubular portion 40a and a radially-extending portion 40b. The tubular portion 40a has external threads 40c for mating with the threads of the glove bore 32. The radially-extending portion 40b includes a plurality of circumferentially spaced apart threaded bolt holes 40d. The outer flange 42 has a tubular portion 42a and a radially-extending portion 42b. The tubular portion 42a has external threads 42c for mating with the threads of the glove bore 32. The radially-extending portion 42b includes a plurality of circumferentially spaced apart threaded bolt holes 42d.

The flanges 40, 42 and base 12 are configured and dimensioned so that the flange bolt holes 40d, 42d and the base bolt holes 36 align. The glove connector 38 is located between the outer surface of the front wall 24 and the inner surface of the radially-extending portion 42b of the outer flange 42. The connector 38 may include bores 38a or slots that align with the outer flange bolt holes 42d and the base bolt holes 36. As the flanges 40, 42 are moved into the wall 20, the outer flange 42 secures the connector 38 and glove 34 to the base. Further compressive force is applied to the flanges 40, 42 by threading bolts 43 within the bolt holes 36, 38a, 40d, and 42d and tightening the bolts 43.

Referring again to FIG. 2, the left wall 20 of the base 12 further includes a lock block 44 coupled there for use with a latch 45 to be described in detail below. The lock block 44 also acts as a handle for carrying the enclosure 10. Alternatively, the lock block 44 can be coupled to the lid 14 and the latch 45 can be coupled to the base 12. In the preferred embodiment, the lock block 44 is formed during molding of the base 12. Alternatively, the lock block 44 can be formed separately and connected to the left wall 20 by adhesive, fasteners, welding, or the like.

Referring to FIGS. 2A and 2B, the lock block 44 includes a lower grounding notch 46 (shown in phantom) and an upper locking notch 48. The lower notch 46 has a height H1 and H2 of about 0.25 inches and about 0.375 inches, respectively and an angled or tapered surface 46a. The upper notch 48 has a height H3 of about 0.625 inches. The lock block 44 also includes a vertically extending L-shaped slot 50. Alternatively, the slot 50 can have another shape that allows the lock block 44 and latch 45 to function as described below. The notches 46 and 48, and slot 50 cooperate with components of the latch 45, as discussed below.

Referring to FIGS. 1, 2 and 4, the right wall 22 of the base 12 defines a threaded test port or bore 52 for receiving a test plug 54. A preferred median diameter of the bore 52 is about 0.25 inches. The test plug 54 is commercially available from the Texas Fairfax Company located in Hawkins, Tex. Test plug 54 typically comprises a support body member 55, a self-sealing member 57 and a cap 59. The self-sealing member 57, typically made from rubber or other elastomeric materials, and cap 59 normally prevent the air inside enclosure 10 environment from escaping to the ambient atmosphere or environment outside of the enclosure 10. The self-sealing member 57 defines a lead-in channel 57a and a normally closed channel 57b. The support body member 55 is threadably connected to wall 22 and may taper inward to compress the self-sealing member 57 so that the channel 57b is forced closed.

Referring to FIG. 2, the right wall 22 of the base 10 further includes a support member 56. The support member 56 is optional. The support member 56 adds rigidity to the right wall 22, supports the hinge 16, and acts as a carrying handle for the enclosure 10.

Referring to FIG. 1, the base 12 further includes a flange 58 with an outwardly extending portion 58a and an upstanding lip 58b to form a channel 60. The channel 60 preferably has a width of about 1 inch and receives an O-ring gasket 62. The channel 60, gasket 62 and lid 14 are configured and dimensioned such that when the gasket 62 is disposed within the channel 60 the upper surface of the gasket 62 is concave and the gasket 62 forms an air-tight seal between the base 12 and lid 14, when the lid 14 is closed. For the air-tight seal to be achieved, the lower surface 14b of the lid 14 should come into substantially continuous contact with the gasket 62, which is achieved by configuring and dimensioning the channel 62 and lid 14 so that when the lid 14 is closed the bottom surface 14b of the lid 14 is below or equal to the top edge of the lip 58b of the flange 58. The gasket 62 is preferably formed of neoprene or other elastomeric material. The gasket 62 is optionally secured in the channel 60 with adhesive.

Referring again to FIG. 2, the lid 14 includes a first end 64 secured to the hinge 16 and a second free end 66. The lid 14 is movable between an open position (shown in FIG. 2) and a closed position (shown in FIG. 5). Referring to FIG. 5, the lid 14 further includes a first portion 68 and an extending second portion 70. The extending second portion 70 extends beyond the flange 58. The extending second portion 70 includes a bore 72 that rotatably receives the latch 45.

Referring to FIGS. 6 and 7, the latch 45 in the preferred embodiment includes a shaft 74 and a perpendicularly extending handle 76. The shaft 74 includes an upper end 74a connected to the handle 76 and a lower end 74b. The shaft 74 further includes a lower portion 78, a central portion 80, and an upper portion 82. The lower and upper portions 78 and 82 have substantially the same diameter and the central portion 80 has a smaller diameter so that the torsional strength of the central portion 80 is substantially less than that of the upper and lower portions 78 and 82. The preferred diameter of the upper and lower portions 78, 82 is about 0.625 inches and the preferred minimum diameter of the central portion 80 is about 0.375 inches. The lower portion 78 of the shaft 74 is adapted to receive a fastener 84 for coupling a guiding projection 86 to the lower end 74b of the shaft 74. The guiding projection 86 and fastener 84 are optional. The guiding projection 86 is preferably formed of a resilient material such as steel or plastic.

The latch 45 also includes a C-shaped snap ring 88 for securing a washer 90 to the shaft 74. The washer 90 prevents the latch 45 from moving in the direction D1. The lower portion 78 of the shaft 74 also includes a locking projection 92 extending outwardly therefrom. In an alternative embodiment, the latch can include more than one locking projection 92 and the lock block 44 (as shown in FIG. 2A) should be modified to work with such a modified latch. The guiding projection 86 and the locking projection 92 are angularly offset at about 90 degrees to one another as best seen in FIG. 9. In another embodiment, the guiding projection 86 and locking projection 92 may not be angularly offset.

Referring to FIG. 6, the lower portion 78 of the latch 45 further includes a circumferentially extending shoulder 94 disposed above the lid 14 for aiding in retaining the latch 45 to the lid 14 when the handle 76 is broken off. The shoulder 94 also acts as a bearing surface for spring 96. The spring 96 is a coil spring that acts to absorb the relative movement between the latch 45 and the extending second portion 70 of lid 14. An optional, light-duty spring is preferable. If more spring force is desired, however, a stronger spring can be used or circumferentially spaced bores can be located in the shoulder or lid, where each such bore receives a ball bearing and a spring.

Preferably, the shaft 74, handle 76, and shoulder 94 are formed as a single, unitary molded piece of plastic. The locking projection 92 is joined to the shaft 74 after the shaft 74 is inserted through the bore 72 of extending portion 70 in the lid 14. In an alternative embodiment, the latch can be formed as a number of different pieces and the present invention is not limited to the construction discussed above. For example, the shaft 74 can be formed of two-pieces. The first piece includes the lower end 74b of the shaft 74 and the locking projection 92 and has a portion of the shaft 74 above the locking projection 92. The second piece includes the handle 76, the upper end 74a, the central portion 80 and the shoulder 94. In such an embodiment, the fastener 84 can be long enough to securely connect the two pieces.

Referring to FIGS. 6, 7, and 2A, the thickness t_{G} of the guiding projection 86 and the height H1 of the lower notch 46 are such that when the guiding projection 86 enters the notch 46, the lid 14 is forced closed and the projection has a tight fit within narrow portion of notch 46. In other words, as shown in FIG. 2A, top surface 46a is tapered downward to create a cam surface such that as guiding projection 86 slides relative to surface 46a, it is forced downward thereby rotating latch 45 and lid 14 downward to facilitate closure of lid 14. The thickness of the t_{L} of the locking projection 92 and height H2 of the upper notch 48 are such that when the locking projection 92 enters the notch 48 an interference fit is exhibited.

Referring to FIG. 1, the dimensions of the enclosure 10 are sufficient to receive standard letter size envelopes or smaller or envelopes approximately 9 inches by 12 inches and small packages. Sample dimensions of the enclosure 10 are a length L of about 32 inches, a width of about 18 inches and a height of about 20 inches. Larger or smaller enclosures, however, can be made to accommodate other sizes of mail.

As shown in FIGS. 1-4, the thickness of the walls 18-26 of the base 12 is t_{B} and the thickness of the lid is t_{LID}. Preferably, all of the base walls 18-26 have substantially the same thickness t_{B}. When the latch 45 is moved from the unlocked position (shown in FIG. 6) to the locked position (shown in FIG. 7), the base 12 through the flange 58 exerts force on the lid 14. The lid 14 should be of sufficient thickness t_{LID} to withstand this force. Preferably, the lid 14 is substantially thicker than the walls 18-26 of the base so that the lid 14 has such strength. In a preferred embodiment, the thickness t_{LID} of the lid 14 is greater than the thickness t_{B} of the base walls. More preferably, the lid 14 is at least 0.125 inch thicker than the base walls 18-26. Most preferably, when the thickness of the base walls is 0.25 inches the thickness of the lid is 0.375 inches, when the thickness of the base walls is 0.375 inches the thickness of the lid is 0.5 inches, and when the thickness of the base walls is 0.5 inches the thickness of the lid is 0.75 inches.

Referring to FIGS. 1 and 2, use of the enclosure 10 will now be discussed. When a user identifies a piece of suspicious mail 30, the user opens the lid 14 of the enclosure 10 and places the mail 30 within the opening 28 of the base 12. The user may also place a concealed-blade letter opener 100 in the opening 28. A concealed-blade letter opener 100 is preferred so that the gloves cannot be cut. Referring to FIGS. 1 and 6 and 9, with the latch 45 in the unlocked position, the locking projection 92 is aligned with the vertical slot 50 in the lock block and the guiding projection 86 is aligned with the vertical slot 50. As a result, the user can move the lid 14 to the closed position, as shown in FIG. 5. Referring to FIG. 2, when the lid 14 is partially closed, the guiding projection 86 enters the lower notch 46 of the lock block 44 and the cam surface 46a forces guiding projection 86 and the lid 14 toward the closed position. Once the lid 14 is fully closed, the lid 14 contacts the gasket 62 (shown in FIG. 1) and the lid 14 and base 12 form a substantially air tight chamber 102, as shown in FIG. 5. The user then rotates the latch 45 in the direction R1 (as shown in FIG. 9) from the unlocked position (shown in FIGS. 6 and 9) to the locked position (shown in FIGS. 7 and 10). In the locked position, as shown in FIG. 10, the locking projection 92 enters the upper notch 48 of the lock block 44 and an interference fit is achieved between these components. The guiding projection 86 also rotates within the lower notch 46.

The user then inserts their hands into the gloves 34, as shown in FIG. 3 and opens the mail 30, shown in FIG. 5, using the letter opener 100 if desired. The user can visually determine whether a potentially hazardous agent is within the mail 30 by determining if the agent is visible against the high-contrast left, right, and bottom walls 20, 22, or 18, respectively, of the base 10.

To sample the potentially contaminated air contained within enclosure 10, cap 59 is first removed from body member 55 and a needle 104 is inserted into lead-in channel 57a until it abuts the normally closed channel 57b. The needle is then pushed through channel 57b until it is in fluid communication with the air inside enclosure 10 or contacts the sample. The air or material is then withdrawn through the needle with a syringe (not shown). After the sampling is completed, the needle is withdrawn and channel 57b closes behind the needle to once again seal the enclosure. Cap 59 then can be replaced on to body member 55.

If the material is tested and determined to be harmful, the enclosure can be substantially permanently locked to ensure that tampering cannot occur without visible evidence. This is done by further rotating the latch 45 in the direction R2, as shown in FIG. 10 until the force applied is sufficient to break the shaft 74 of the latch 45 at the weakened central portion 80, as shown in FIGS. 8 and 11. As a result, the locking projection 92 remains in the upper notch 48 and the enclosure 10 cannot be opened without visibly tampering with the latch 45 to unlock it. This could be useful in establishing a chain of custody of evidence for a legal action.

If the material is tested and determined to be benign, the enclosure 10 can be unlocked by rotating the latch in the direction R3, as shown in FIG. 10, so that the locking projection 92 returns to alignment with the vertical notch 50, as shown in FIG. 9 and the guiding projection 86 returns to alignment with notch 51. In this position, the lid 14 is unlocked and can be opened to retrieve the mail 30 (refer to FIG. 5).

The present invention is not limited to the latch 45 shown. Alternative latches such as commercially available lockout tag out latches can be used or any other type of latch that securely locks the lid can be used. The tamper-identification feature is optional.

By way of example, FIGS. 6A-1 lA illustrate a second embodiment of the latch 145 that includes a guiding projection 186 and a locking projection 192. The grounding projection 186 and locking projection 192 are angularly offset from one another by about 180 degrees. The latch 145 also includes a weakened central portion 180. The latch 145 operates similarly to the latch 45 and is shown in an unlocked position in FIGS. 6A and 9A, in a locked position and unbroken in FIGS. 7A and 10A and in a locked position and broken in FIGS. 8A and 11A. Thus, the latch 145 offers the tamper-identification feature of latch 45.

Referring to FIG. 1, in another embodiment, the lid 14 can be completely separate from the base 10 and removable from the base 10. In such an embodiment, the lid 14 can be secured to the base 10 by a plurality of latch with or without the tamper-identification feature.

Referring to FIGS. 1 and 12, additional tools can be disposed within the enclosure 10, as shown in phantom. For example, a removable tray 200 can be disposed on the bottom wall 18 to provide a clean testing environment. The tray 200 can receive one or more testing materials or “smart” or responsive tags 202 and 204. Such tags 202 and 204 are commercially available testing devices that react to the presence of a predetermined substance. Such tags 202 and 204 are commercially available from RUME Corporation of Farmingdale, NY. Tag 202 requires contact with the substance, in which case a holding instrument 206 can be used to contact the tag 202 with the sample of the material to be tested. Tag 204 is a non-contact device so that it reacts to the presence of air-borne predetermined substance. When contact and non-contact tags are used, the test port 54 (as shown in FIG. 4) can be optional. When a non-contact tag 204 is used the glove ports 32 and test port 54 are optional.

Referring to FIG. 13, a second embodiment of an enclosure 210 is shown. The enclosure 210 includes a two-part base 212 with a U-shaped metal frame 212a and a plastic liner 212b. The metal frame 212a includes a bottom wall 218, and left and right side walls 220 and 222. The space between the side walls 220 and 222 forms an opening 224. Each of the side walls 220 and 222 includes an outwardly extending flange 226. The frame may include additional frame members to increase the rigidity of the frame 212a.

The plastic liner 212b includes a bottom wall 227a, four upwardly extending side walls 227b and a flange 227c. The side walls 227b include glove ports 232, test port 234, and a lock block 236 for coupling the hinge 16 and lid 14 to the liner 212b as discussed above. The flange 227c is configured like flange 58 to define a channel for receiving a gasket 62 (as shown in FIG. 1). Bolts (not shown) through the flanges 226 and 227c secure the plastic liner 212b to the frame 212a. The bolts can be replaced with other fasteners or fastening techniques, such as adhesive. The lock block can also be connected to the metal frame 212a. The lid 14 includes a latch as previously discussed for securing the lid in a closed position and providing tamper-identification.

The plastic liner 212b can be molded of a single piece of plastic that is thin since the metal frame adds structural rigidity to the liner. Preferred dimensions of plastic liner wall thickness and lid thickness are about 0.25 inches and about 0.375 inches, respectively. Enclosure 210 have a length of about 32 inches long, have a height of about 22 inches, and a width of about 16 inches.

Preferably, the plastic liner 212b is formed of a transparent material and the metal frame 212a is formed of steel. Once the plastic liner 212b is placed within the, metal frame 212a, the enclosure 210 can be used similarly to the enclosure 10.

While various descriptions of the present invention are described above, it is understood that the various features of the present invention can be used singly or in combination thereof. The present invention is not limited to the dimensions of the various components and features as discussed above, as such dimensions are exemplary. In addition, latch that lock and/or unlock using a key, mechanical or electronic combination, or remote, electronic signals can also be used. The enclosure can also be used with tools such as a spray that kills or neutralizes the bacterial and/or chemical agents therein. Multiple pieces of mail can also be deposited into the enclosure to be open and/or tested once the enclosure is closed. If multiple pieces of mail are to be opened, a plurality of trays and smart tags can also be used. The base could have an opening for a pivotal closure wall that is other than top-opening so that instead of drop-in access or vertical loading, the mail is horizontally loaded into the enclosure. In addition, the glove ports can be located on a wall other than the front wall or on the lid and the test port can be located on a wall other than the right wall or on the lid. The location of the hinge 16 and the lock block 44 (as shown in FIG. 2) can be moved to other walls so long as the enclosure functions as discussed above. The features of one embodiment can be used with the features of another embodiment. Therefore, this invention is not to be limited to the specifically preferred embodiments depicted therein.

I claim:

1. An enclosure capable of sealing a contaminated package and opening same comprising:
a housing member having a base and a lid coupled to the base, wherein the housing member is adapted to receive said package;
a latch coupled to the housing member to prevent fluid communication between an environment inside the enclosure and outside environment;
a self-sealing valve disposed on the enclosure to permit selective sampling of the environment inside the enclosure; and
at least one glove connected to the housing member, said at least one glove is adapted to receive a user's hand such that the user may manipulate the package after the package is sealed inside the enclosure to determine the content of the package;
wherein the latch comprises a breakaway handle that can be separated from the latch to minimize the possibility of separation of the lid from the base after the package is sealed within the enclosure.

2. The enclosure of claim 1, further comprises an O-ring disposed between the lid and the base.

3. The enclosure of claim 2, wherein the O-ring is disposed within a channel formed between the lid and the base.

4. The enclosure of claim 1, wherein the enclosure comprises two gloves.

5. The enclosure of claim 1, wherein the self-sealing valve comprises a body member and a self-sealing member, said self-sealing member defines a normally closed channel wherein said normally closed channel is adapted to allow an insertion of a hollow needle to selectively sample the environment inside the enclosure.

6. The enclosure of claim 5, wherein the self-sealing valve further comprises a lead-in channel to guide the insertion of the hollow needle.

7. The enclosure of claim 5, wherein the self-sealing valve further comprises a cap coupled to the body member.

8. The enclosure of claim 1, wherein the latch is disposed on one of either the lid or the base and comprises a shaft and a first projection coupled to the shaft, and wherein the breakaway handle is connected to the shaft by a weakened section, such that when a user actuates the handle the first projection cooperates with a first notch defined on the other one of either the lid or the base to couple the lid to the base.

9. The enclosure of claim 8, wherein the latch further comprises a second projection coupled to the shaft, such that said second projection cooperates with a tapered second notch defined on the other one of either the lid or the base when the user actuates the handle to assist the coupling of the lid to the base.

10. The enclosure of claim 8, wherein after the lid is coupled to the base, the breakaway handle may be separated from the shaft proximate to the weakened section to minimize the possibility of separating the lid from the base.

11. The enclosure of claim 1, wherein the package is a letter.

12. The enclosure of claim 1, further comprises an instrument disposed therein for opening the package.

13. The enclosure of claim 1, further comprises testing materials disposed therein to identify the contamination.

14. An enclosure capable of sealing a contaminated package and opening same comprising:
a housing member having a base and a lid coupled to the base, wherein the housing member is adapted to receive said package;
a latch coupled to the housing member to prevent fluid communication between an environment inside the enclosure and outside environment; and
at least one glove connected to the housing member, said at least one glove is adapted to receive a user's hand such that the user may manipulate the package after the package is sealed inside the enclosure to determine the content of the package;
wherein the latch comprises a breakaway handle that can be separated from the latch to minimize the possibility of separation of the lid from the base after the package is sealed within the enclosure.

15. The enclosure of claim 14, wherein the latch is disposed on one of either the lid or the base and comprises a shaft and a first projection coupled to the shaft, and wherein the breakaway handle is connected to the shaft by a weakened section, such that when a user actuates the handle the first projection cooperates with a first notch defined on the other one of either the lid or the base to couple the lid to the base.

16. The enclosure of claim 15, wherein the latch further comprises a second projection coupled to the shaft, such that said second projection cooperates with a tapered second notch defined on the other one of either the lid or the base when the user actuates the handle to assist the coupling of the lid to the base.

17. The enclosure of claim 15, wherein after the lid is coupled to the base, the breakaway handle may be separated from the shaft proximate to the weakened section to minimize the possibility of separating the lid from the base.

18. An enclosure capable of selectively sampling a sealed environment contained therein comprising:
a housing member having a base and a lid coupled to the base, wherein the housing member is adapted to receive a package;
an O-ring disposed between the lid and the base, said O-ring is disposed within a channel formed between the lid and the base;
a self-sealing valve disposed on the enclosure to permit selective sampling of the sealed environment inside the enclosure; and
at least one glove connected to the housing member, and said at least one glove is adapted to receive a user's hand such that the user may manipulate the package after the package is sealed inside the enclosure to determine the content of the package.

19. The enclosure of claim 18, wherein the self-sealing valve comprises a body member and a self-sealing member, said self-sealing member defines a normally closed channel wherein said normally closed channel is adapted to allow an insertion of a hollow needle to selectively sample the environment inside the enclosure.

20. The enclosure of claim 19, wherein the self-sealing valve further comprises a lead-in channel to guide the insertion of the hollow needle.
